(19) United States
(12) Patent Application Publication
(10) Pub. No.: US 2010/0224041 A1
(43) Pub. Date: Sep. 9, 2010

(54) FOOD SLICER

(75) Inventors: Eric J. MELTON, Alta Loma, CA (US); Lynette M. SETLICH, Chino, CA (US); James B. SHEFFLER, Chino Hills, CA (US); Richard D. HECK, Lucerne Valley, CA (US)

Correspondence Address: SUGHRUE MION, PLLC, 2100 PENNSYLVANIA AVENUE, N.W., SUITE 800, WASHINGTON, DC, 20037, US

(73) Assignee: SUNKIST GROWERS, INC., Sherman Oaks, CA (US)

(21) Appl. No.: 12/716,676

(22) Filed: Mar. 3, 2010

Related U.S. Application Data
(60) Provisional application No. 61/157,104, filed on Mar. 3, 2009.

(51) Int. Cl. B26D 1/00; A47J 43/04; B26D 7/00; B26D 1/06

(52) U.S. Cl. 83/13; 99/538; 83/167; 83/762

(57) ABSTRACT

A food slicing apparatus includes a container, a removable top, and a slicing device that includes blades and slides relative to the top. The top defines a patterned hole which accommodates the blades as the slicing device slides from an open position in which the blades are spaced from the top, toward a closed position in which the blades are disposed through the patterned hole. A piece of food that is placed on the top below the blades and is sliced by pressing the slicing device against the food and the sliced pieces are moved into the container by further pressing on the slicing device thereby pressing the frame of the slicing device against the food. The slicing device and top are thereafter removed from the container, and a lid is placed on the container to accommodate the food after it has been sliced.

### BACKGROUND OF THE INVENTION

1. Field of the Invention

The exemplary embodiment relates to a device for slicing and storing food and a method of slicing and storing food.

2. Background of the Invention

In a bar environment, it is necessary to quickly slice fruit as it is needed without creating a mess and with minimal contact with the fruit to avoid contaminating the fruit by the bartender.

Typically knives are used to slice fruit and/or vegetables in a small kitchen or bar environment, which requires a large amount of time. Furthermore, this requires that the user hold the fruit while slicing the fruit, which can be dangerous for the user. In addition, when the user holds the fruit, there is an increased risk of contamination for the consumer.

After the fruit is sliced, any pieces of fruit that are not immediately used must be moved into a container by the user in order to be stored. This requires further handling by the user, increasing the risk of contamination and increasing the time required to slice and store the fruit.

Thus, there remains a need for an improved apparatus for slicing food such as fruit and for an improved method of slicing and storing fruit.

### SUMMARY OF THE INVENTION

According to an aspect of the present invention, there is provided a food slicing apparatus including a container defining a storage cavity; a blade guiding top defining a patterned hole; and a slicing device movably attached to the container and including a cutting tool positioned to fit through the patterned hole in the blade guiding top, wherein the cutting tool is movable relative to the blade guiding top between an open position in which the cutting tool is spaced from the cutting tool defining top and a closed position in which the cutting tool is disposed through the patterned hole in the blade guiding top.

The slicing device may include a plurality of guide projections that are slidably connected to the container. A length of each of the guide projections may be greater than a length of the cutting tool. The guide projections may be equally spaced about the container. A number of the guide projections may be two.

The container may include a plurality of guides wherein each of the guide projections of the slicing device slidably engages a respective one of the guides. The apparatus may further include a friction locking mechanism disposed between the guide projections of the slicing device and the guides of the container. The apparatus may further include a spring disposed along at least one of the guides of the container which biases the slicing device toward the open position.

The slicing device may include a pair of opposing handles. The slicing device may include a frame having a bottom surface from which the cutting tool extends and a flat top surface opposing the bottom surface. The slicing device may further include a frame and the cutting tool may be removably attached to the frame.

The blade guiding top may be elastic. The patterned hole may include an outer periphery that has a plurality of concave and convex portions. The patterned hole may include a plurality of slots extending outwardly from a center of the patterned hole.

The cutting tool may include a plurality of blades wherein each of the blades is disposed in one of the slots in the closed position. The blade may include an outer periphery that corresponds to an outer periphery of the patterned hole.

The container may include a main body and the blade guiding top is removable from the main body of the container. The apparatus may further include a cup disposed in the main body and removably supported from a top edge of the main body.

According to another aspect of the exemplary embodiment, there is provided a method of slicing food including placing a piece of food on a top of a container having a patterned hole at a position at least partially covering the patterned hole; sliding a slicing apparatus relative to the container, the slicing apparatus having a frame and a blade; slicing the piece of food with the blade; and moving the sliced pieces of food through the patterned hole into the container by pressing the frame of the slicing apparatus against the sliced pieces of food.

According to another aspect of the exemplary embodiment, there is provided a method of slicing and storing a food product using a food slicing apparatus comprising a container, a blade guiding top being elastic and having a patterned hole therethrough, and a slicing device including a frame and a plurality of blades extending from the frame and radially spaced about a longitudinal axis, an outer periphery of the blades corresponding to an outer periphery of the patterned hole, the method including placing the food product along the longitudinal axis below the blades and on the blade guiding top at least partially within the outer periphery of the patterned hole; slicing the food product into a plurality of pieces by moving the slicing device along the longitudinal axis and pressing the blades of the slicing device through the food product and into the patterned hole; forcing the pieces of the food product through the patterned hole on which the sliced food product is located by pressing the frame of the slicing device against the pieces of the food product, wherein the pressing of the frame against the pieces allows the pieces of food product to pass through the patterned hole and into the container.

The blade guiding top may be elastic, wherein the method may further include forcing the pieces of the food product through the patterned hole includes deforming the patterned hole. The method may further include removing the slicing device and the top from the container and placing a lid on the container to enclose the pieces of the food product within the container.

According to the exemplary embodiments, the food slicing apparatus of the present invention, allows a user to quickly slice a piece of fruit with a reduced amount of handling and time and allows for convenient storage of the sliced pieces of fruit immediately after slicing.

### BRIEF DESCRIPTION OF THE DRAWINGS

The above and/or other aspects of the exemplary embodiment will become apparent and more readily appreciated from the following description taken in conjunction with the accompanying drawings, in which:

FIG. 1 is a perspective view of the claimed invention;

FIG. 2 is an elevation view of the claimed invention showing a first side;

FIG. 3 is an elevation view of the claimed invention showing a second side;

FIG. 4 is a top view of the claimed invention;

FIG. 5 is a bottom view of the claimed invention;

FIG. 6 is a bottom perspective view of the claimed invention;

FIG. 7 is an exploded perspective view illustrating all of the components of an exemplary embodiment of the claimed invention;

FIG. 8 is a bottom perspective view of a lid;

FIG. 9 is an alternative embodiment of the blade guiding top;

FIG. 10 is an alternative embodiment of the cup; and

FIG. 11 is a flow chart of an exemplary embodiment of the method of the present invention.

### DESCRIPTION OF THE EXEMPLARY EMBODIMENTS OF THE INVENTION

The exemplary embodiments of the present invention will now be described in detail while referring to the accompanying drawings. Throughout respective figures, the same or corresponding members or parts are identified by the same reference numerals and characters.

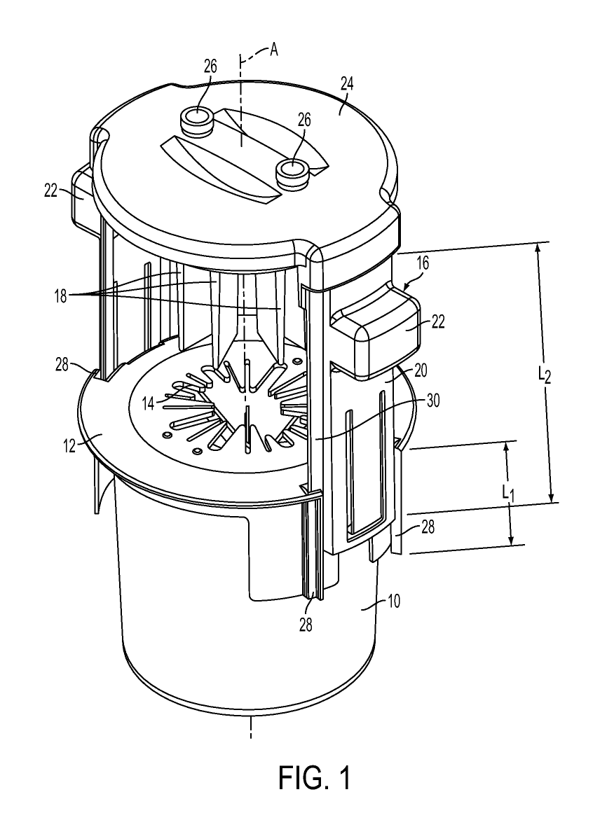

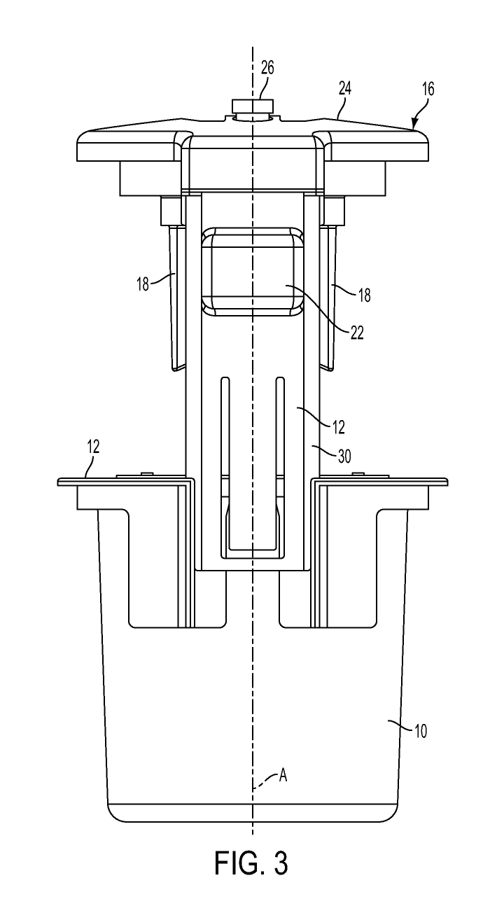

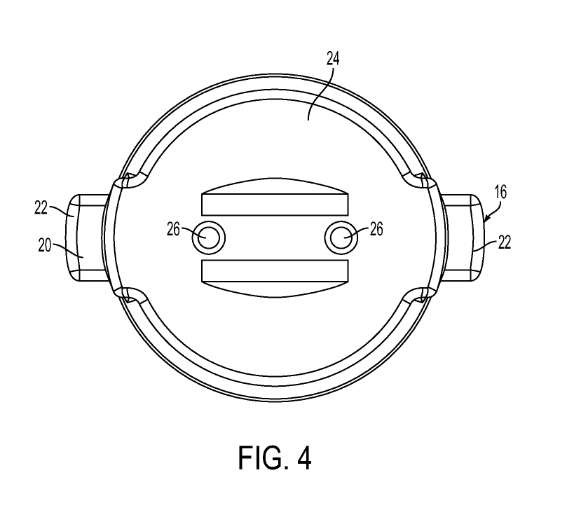

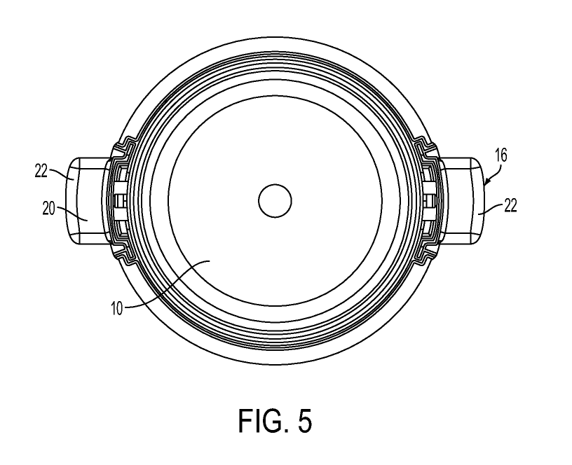

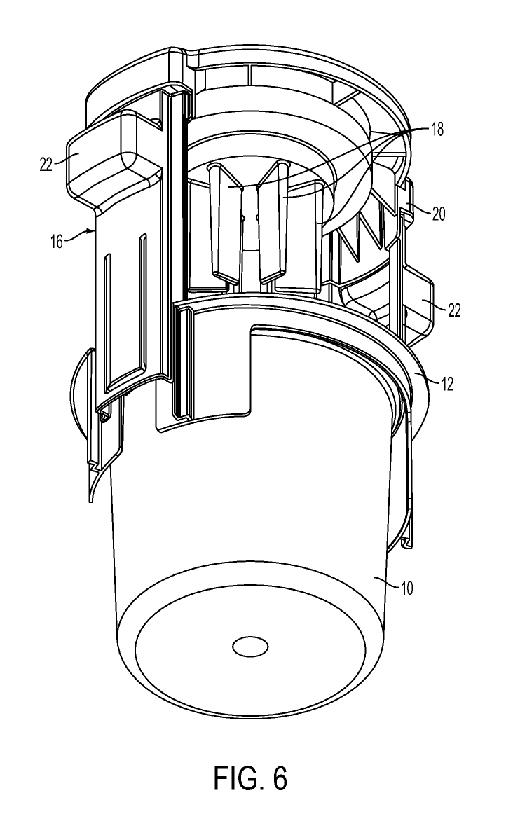

A food slicing apparatus that sectionizes or slices fruits and/or vegetables is shown in FIGS. 1-6. The apparatus includes a container 10 defining a storage cavity and a blade guiding top 12 defining a patterned hole 14 such that the blade guiding top 12 partially closes the container 10. A top surface of the blade guiding top 12 is elastic such that the patterned hole 14 can be stretched open in response to fruit being pushed therethrough. For example, the patterned hole 14 is an elastic rubber gasket disposed in the blade guiding top 12.

A slicing device 16 is movably disposed on the blade guiding top 12 and is movable in a vertical direction relative to the container 10. In the exemplary embodiment of FIGS. 1-6, the slicing device 16 is slidable relative to the top 12. The slicing device 16 includes a cutting tool 18 rigidly and removably attached to a frame 20 wherein the frame 20 and cutting tool 18 both slide vertically up and down together between an open, or fruit loading, position and a closed, or fruit slicing, position. The cutting tool 18 may be a plurality of sharp blades radially spaced about a longitudinal axis A, as shown in FIGS. 1, 2, 6, and 7. The blades 18 are positioned such that the blades 18 fit through the patterned hole or patterned holes 14 in the blade guiding top 12. The patterned hole or patterned holes 14 are large enough to accommodate a piece of fruit product that has been sliced. The frame 20 may include a pair of opposing handles 22 on sides thereof. The frame 20 may also include a flat top surface 24 which is opposed to a bottom surface from which the blades 18 extend. In this case, a user may push on either the handles 22 or the flat top surface 24.

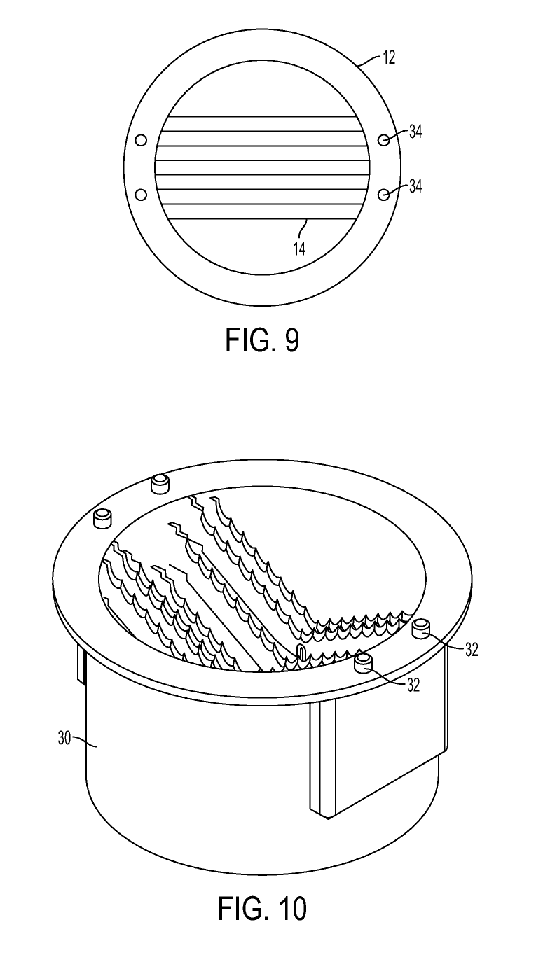

The blades 18 are removable and exchangeable so that many different blade arrangements can be used with the apparatus. The exemplary embodiments illustrate screws 26 that detachably attach the blades 18 to the frame 20. The exemplary embodiments of FIGS. 1-7 illustrate a blade that makes eight equal wedges, but the blade arrangement may be configured to make a plurality of parallel slices or a different number of wedges. For example, FIGS. 9 and 10 illustrate the top 12 and cup 31 of an alternative exemplary embodiment for making parallel slices. The blade guiding top 12 is removable from the container 10, wherein a particular blade guiding top 12 having a patterned hole 14 that corresponds to the blades 18 may be used.

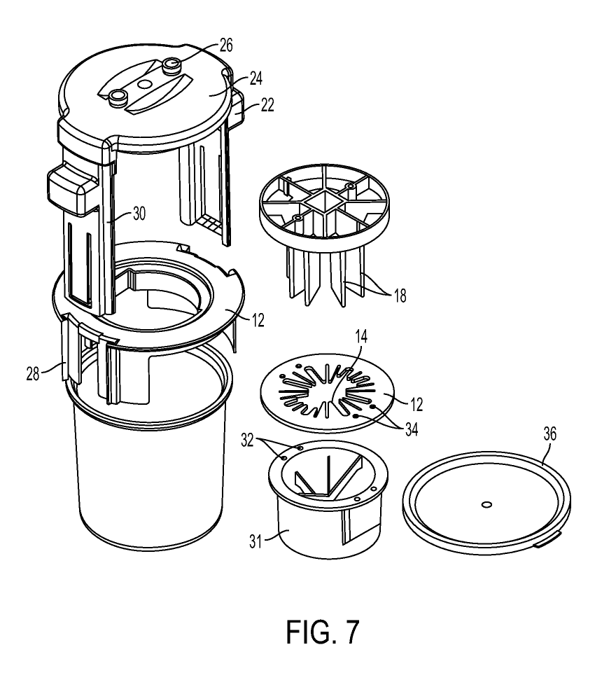

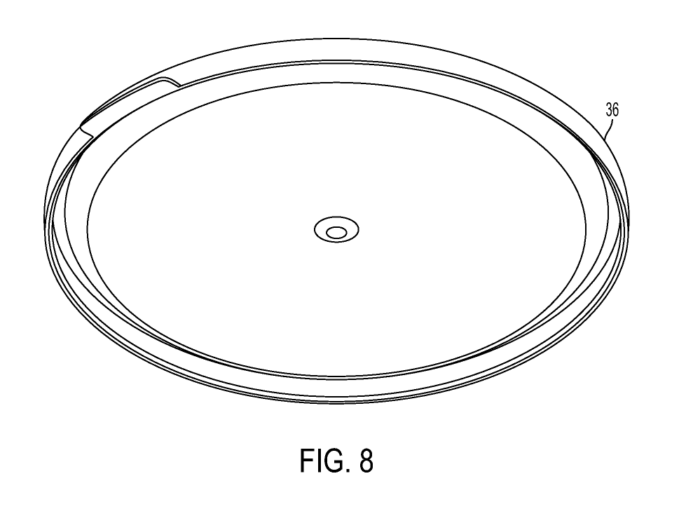

The patterned hole 14 includes an outer periphery that has a plurality of concave and convex portions, as shown in FIGS. 1 and 7. The patterned hole 14 may include a plurality of slots extending outwardly from a center of the patterned hole 14, wherein each of the blades 18 is disposed in one of the slots in the closed position, as best shown in FIG. 1. The cutting tool, e.g., the plurality of blades, 18 includes an outer periphery that corresponds to the outer periphery of the patterned hole.

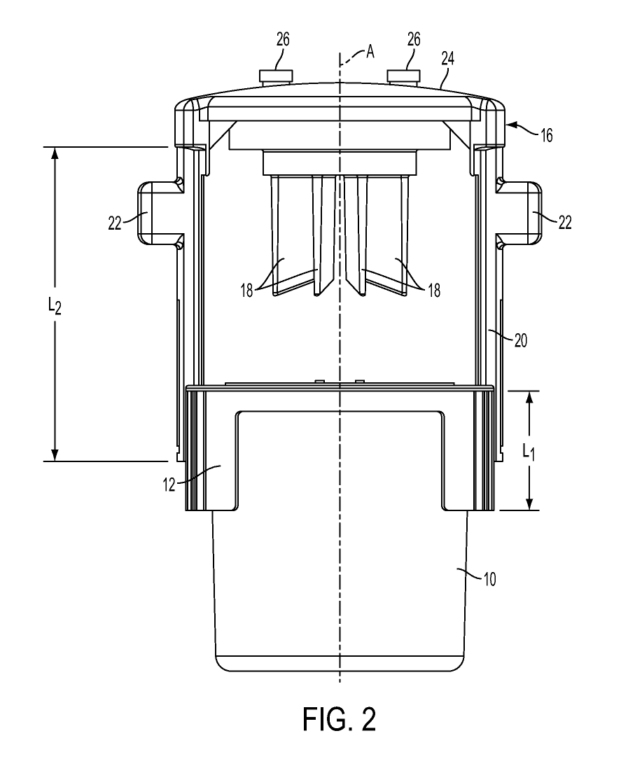

The blade guiding top 12 includes a pair of guides 28 with one guide 28 on each side of the container. The guides 28 may be a pair of opposed channels, as shown in the FIGS. 1-3 and 5-7. The frame 20 of the slicing device 16 includes guide projections 30, or rails, that slide along or within the guides 28 of the blade guiding top 12. As shown in FIGS. 1-7, the guide projections 30 are equally spaced about the container 10, and there are two guide projections 30. The length L1 of the guides 28 and the length L2 of the guide projections 30 are such that in a fruit loading position an average piece of fruit, preferably 3 inches in diameter, will fit between the blade guiding top 12 and a bottom of the blades 18, and the slicing device will remain stably disposed within the rails 28. The length of the guide projections 30 is greater than the length of the blades 18 such that in the open position, there will be a space between the end of the blades 18 and the top 12 of the container 10, as best shown in FIG. 2.

The slicing device 16 is held upwardly in the open, fruit loading position through a friction locking mechanism (not shown) disposed between the guides 28 of the container 10 and the guide projections 30 of the slicing device 16. Alternatively, a spring (not shown) may be disposed along at least one of the guides 28 of the container 10 which biases the slicing device 16 toward the open position.

A removable cup 31, illustrated in FIGS. 7 and 10, is disposed in the container 10 and hangs from, or is supported by, the top edge of the container 10. This cup 31 includes extensions 32 that fit through small patterned holes 34 defined in the elastic top 12 to hold the top 12 in place during slicing.

Although the blades 18 and respective patterned hole 14 in the blade guiding top 12 are shown in a specific arrangement in the exemplary embodiments, the blades 18 may be removed and replaced with a different arrangement of blades 18 and accordingly, the blade guiding top 12 will have a different shaped patterned hole to accommodate those blades 18.

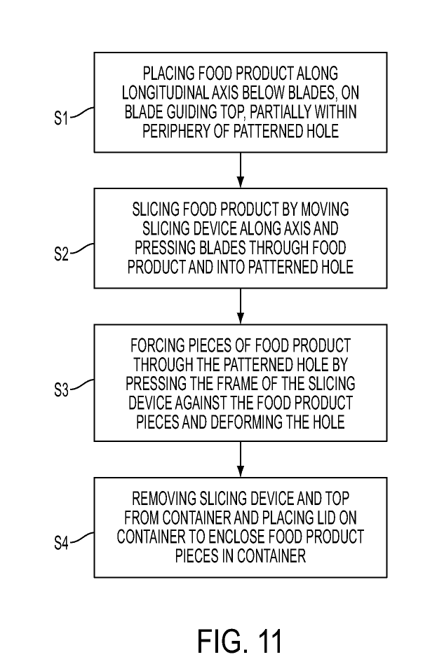

In operation, a piece of food product is placed and oriented along the longitudinal axis A below the blades 18 and on the blade guiding top 12 at least partially within the outer periphery of the patterned hole 14 at step S1, as shown in FIG. 11. The food product is sliced into a plurality of pieces by moving the slicing device 16 along the longitudinal axis A and pressing the blades 18 of the slicing device 16 through the food product and into the patterned hole 14 at step S2. At step S3, the pieces of the food product are forced through the patterned hole 14 on which the sliced food product is located by pressing the frame 20 of the slicing device 16 against the pieces of the food product. The pressing of the frame 20 against the pieces allows the pieces of food product to pass through the patterned hole 14 and into the container 10.

Since the blade guiding top 12 is elastic, the forcing of the pieces of the food product through the patterned hole 14 at step S3 includes deforming the patterned hole 14. The slicing device 16 and the top 12 are removed from the container 10 and a lid 36 is placed on the container at step S4 to enclose the pieces of the food product within the container.

The apparatus and method facilitate the slicing of fruits and/or vegetables in a small kitchen or bar environment at a higher rate than may normally be achieved using a knife or other appliance. The apparatus and method also improve safety both to the user by keeping the blades away from direct contact, and to the consumer by eliminating handling of the fruit product. The apparatus is also convenient because, after the fruit is sliced and pushed into the container, the elastic top prevents fruit product that may be stuck on the blades from being pulled upwardly with the blades. The container also permits convenient storage of the sliced fruit until use.

While the invention has been described in terms of exemplary embodiments, those skilled in the art will recognize that the invention can be practiced with modifications within the spirit and scope of the appended claims.

What is claimed is:

1. A food slicing apparatus comprising:
a container defining a storage cavity;
a blade guiding top disposed on the container and defining a patterned hole;
a slicing device movably attached to the container and including a cutting tool positioned to fit through the patterned hole in the cutting tool guiding top,
wherein the cutting tool is movable relative to the blade guiding top between an open position in which the cutting tool is spaced from the cutting tool defining top and a closed position in which the cutting tool is disposed through the patterned hole in the blade guiding top.

2. The apparatus according to claim 1, wherein the slicing device includes a plurality of guide projections that are slidably connected to the container.

3. The apparatus according to claim 2, wherein a length of each of the guide projections is greater than a length of the cutting tool.

4. The apparatus according to claim 2, wherein the guide projections are equally spaced about the container.

5. The apparatus according to claim 2, wherein a number of the guide projections is two.

6. The apparatus according to claim 2, wherein the top includes a plurality of guides and each of the guide projections of the slicing device slidably engages a respective one of the guides.

7. The apparatus according to claim 6, further comprising a friction locking mechanism disposed between the guide projections of the slicing device and the guides of the top.

8. The apparatus according to claim 6, further comprising a spring disposed along at least one of the guides of the top which biases the slicing device toward the open position.

9. The apparatus according to claim 1, wherein the blade guiding top is elastic.

10. The apparatus according to claim 1, wherein the slicing device includes a pair of opposing handles.

11. The apparatus according to claim 1, wherein the slicing device includes a frame having a bottom surface from which the cutting tool extends and a flat top surface opposing the bottom surface.

12. The apparatus according to claim 1, wherein the slicing device further comprises a frame and the cutting tool is removably attached to the frame.

13. The apparatus according to claim 1, wherein the patterned hole includes an outer periphery that has a plurality of concave and convex portions.

14. The apparatus according to claim 1, wherein the patterned hole includes a plurality of slots extending outwardly from a center of the patterned hole.

15. The apparatus according to claim 14, wherein the cutting tool includes a plurality of blades wherein each of the blades is disposed in one of the slots in the closed position.

16. The apparatus according to claim 1, wherein the blade includes an outer periphery that corresponds to an outer periphery of the patterned hole.

17. The apparatus according to claim 1, wherein the blade guiding top is removable from the container.

18. The apparatus according to claim 14, further comprising a cup disposed in the container and removably supported from a top edge of the container.

19. A method of slicing and storing a food product using a food slicing apparatus comprising a container, a blade guiding top being elastic and having a patterned hole therethrough, and a slicing device including a frame and a plurality of blades extending from the frame and radially spaced about a longitudinal axis, an outer periphery of the blades corresponding to an outer periphery of the patterned hole, the method comprising:
placing the food product along the longitudinal axis below the blades and on the blade guiding top at least partially within the outer periphery of the patterned hole;
slicing the food product into a plurality of pieces by moving the slicing device along the longitudinal axis and pressing the blades of the slicing device through the food product and into the patterned hole;
forcing the pieces of the food product through the patterned hole on which the sliced food product is located by pressing the frame of the slicing device against the pieces of the food product,
wherein the pressing of the frame against the pieces allows the pieces of food product to pass through the patterned hole and into the container.

20. The method of claim 19, wherein the blade guiding top is elastic, and the forcing the pieces of the food product through the patterned hole includes deforming the patterned hole.

21. The method of claim 19, further comprising removing the slicing device and the top from the container and placing a lid on the container to enclose the pieces of the food product within the container.
